(19) United States
(12) Patent Application Publication
(10) Pub. No.: US 2007/0208894 A1
(43) Pub. Date: Sep. 6, 2007

(54) Modification of a layered protocol communication apparatus

(76) Inventors: David S. Curry, San Jose, CA (US); Bruce McLoughlin, Santa Clara, CA (US); Ramkumar Krishnamoorthy, Cupertino, CA (US)

Correspondence Address: DAVIS & ASSOCIATES, P.O. BOX 1093, DRIPPING SPRINGS, TX, 78620, US

(21) Appl. No.: 11/390,488

(22) Filed: Mar. 27, 2006

Related U.S. Application Data
(60) Provisional application No. 60/778,437, filed on Mar. 2, 2006.

(51) Int. Cl. G06F 13/42

(52) U.S. Cl. 710/105

(57) ABSTRACT

A method of modifying a layered protocol communication apparatus includes transferring a control plane from a first processor handling a first layer to a second processor handling a second layer.

### CROSS-REFERENCE TO RELATED APPLICATIONS

This application claims the benefit of U.S. Provisional Application No. 60/778,437 filed on Mar. 2, 2006.

### TECHNICAL FIELD

This invention relates to the field of communications. In particular, this invention is drawn to methods and apparatus for modifying a layered protocol communication apparatus including software modifications associated with different levels of the layered protocol communication apparatus.

### BACKGROUND

Communication networks are used to carry a wide variety of data. Typically, a communication network includes a number of interconnected nodes. Communication between source and destination is accomplished by routing data from a source through the communication network to a destination. Such a network, for example, might carry voice communications, financial transaction data, real-time data, etc., not all of which require the same level of performance from the network.

One metric for rating a communication network is the availability of the network. The network might be used, for example, to communicate data associated with different classes of service such as “first available”, business data, priority data, or real-time data which place different constraints on the requirements for the delivery of the data including the timeframe within which it will be delivered.

Disruption to the network can be very costly. The revenue stream for many businesses is highly dependent upon the availability of the network. The network service provider frequently is under contract to guarantee certain levels of availability to customers and may incur significant financial liability in the event of disruption.

In the interest of ensuring the continued availability of the network or the avoidance of an event that might lead to catastrophic disruption, maintenance is performed on the nodes. Maintenance may also be required to ensure that the nodes support various communication protocols as they evolve over time.

The maintenance process itself can contribute to disruption of network availability. One type of maintenance is a software upgrade. Although nodes with redundant capabilities may avoid the disruption of traffic during the upgrade, providing such redundancies for every node may either be financially or operationally impractical.

Non-redundant elements in the upgrade path represent a significant risk to uninterrupted traffic flow. One approach for performing a software upgrade on non-redundant elements is to physically remove modules with the dated software and replace them with modules for which the software has been updated. This undesirably disrupts all traffic being handled by the module prior to removal.

### SUMMARY

A method of modifying a layered protocol communication apparatus includes transferring a control plane from a first processor handling a first layer to a second processor handling a second layer.

In one embodiment software associated with the first processor is modified prior to transferring the control plane from the second processor back to the first processor for handling.

Another method of modifying a layered protocol communication apparatus includes transferring a first layer handled by a first processor to a second processor handling a second layer.

In one embodiment software associated with the first processor is modified prior to transferring the first layer from the second processor back to the first processor for handling.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a layered protocol model for a communications network.

FIG. 2 illustrates one embodiment of an alternative layered protocol model for a communications network.

FIG. 3 illustrates one embodiment of a communications network component implementing a layered protocol.

FIG. 4 illustrates a software download status prior to performing an upgrade of the software for one element associated with an upper level layer of a layered protocol communication apparatus.

FIG. 5 illustrates the layered protocol communication apparatus after the software upgrade of the element associated with the upper level layer.

FIG. 6 illustrates transfer of layer functionality from processors at one hierarchical level to a processor at a higher hierarchical level.

FIG. 7 illustrates transfer of layer functionality from processors at one hierarchical level to another processor at the same hierarchical level.

FIG. 8 illustrates the apparatus after the software upgrade of the elements normally associated with the transferred layer.

FIG. 9 illustrates the reconfiguration of layer hardware and the transfer of layer functionality to the processors normally associated with the layer.

FIG. 10 illustrates the swap in active/standby status for redundant elements at a higher level.

FIG. 11 illustrates the layered protocol communication apparatus after the software upgrade of another higher level element.

FIG. 12 illustrates one embodiment of process of upgrading the software of a communications node.

FIG. 13 illustrates one embodiment of a preparation phase of the software upgrade process.

FIG. 14 illustrates one embodiment of the beginning of the execution phase of the software upgrade process.

FIG. 15 illustrates one embodiment of transferring a control plane between processors at different levels or alternately at the same level of the element hierarchy.

FIG. 16 illustrates one embodiment of transferring layer functionality between processors.

FIG. 17 illustrates one embodiment of re-configuring low-level hardware handling the data traffic.

FIG. 18 illustrates an alternative embodiment of re-configuring low-level hardware handling the data traffic.

FIG. 19 illustrates one embodiment of the completion of the execution phase of the software upgrade process.

### DETAILED DESCRIPTION

Communication networks frequently rely on protocol layering to simplify network designs. Protocol layering entails dividing the network design into functional layers and assigning protocols for each layer's tasks. The layers represent levels of abstraction for performing functions such as data handling and connection management. Within each layer, one or more physical entities implement its functionality.

For example, the functions of data delivery and connection management may be put into separate layers, and therefore separate protocols. Thus, one protocol is designed to perform data delivery, and another protocol performs connection management. The protocol for connection management is “layered” above the protocol handling data delivery. The data delivery protocol has no knowledge of connection management. Similarly, the connection management protocol is not concerned with data delivery. Abstraction through layering enables simplification of the various individual layers and protocols. The protocols can then be assembled into a useful whole. Protocol layering thus produces simple protocols, each with a few well-defined tasks. Individual protocols can also be removed, modified, or replaced as needed for particular applications.

Implementation of a given functional layer may occur within a single element or be distributed across multiple elements. Generally, however, the layering corresponds to a hardware or software hierarchy of elements. Each layer interacts directly only with the layer immediately beneath it, and provides facilities for use by the layer above it. The protocols enable an entity in one host to interact with a corresponding entity at the same layer in a remote host.

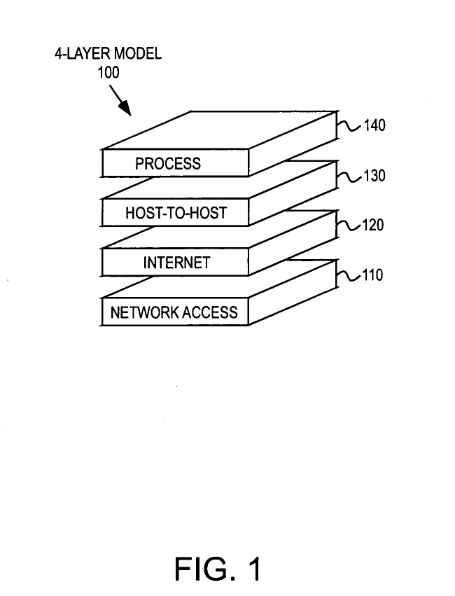

FIG. 1 illustrates one embodiment of a layered protocol design. This four layer model 100 was promulgated by the Defense Advanced Research Projects Agency's (DARPA) Internetwork Project for the United States Department of Defense in the 1970s. The DARPA Internetwork Project is the forerunner of the modern day ubiquitous Internet.

The network access layer 110 is responsible for dealing with the specific physical properties of the communications media. Different protocols may be used depending upon the type of physical network. The Internet layer 120 is responsible for source-to-destination routing of data across different physical networks.

The host-to-host layer 130 establishes connections between hosts and is responsible for session management, data re-transmission, flow control, etc. The process layer 140 is responsible for user-level functions such as mail delivery, file transfer, remote login, etc.

When traversing the layers or “stack” for a given model, the layers are typically numbered ascending from the bottom layer (i.e., Layer 1=network access layer) to the top layer (i.e., Layer 4=process layer). However, enumeration (e.g., numerical or alphabetical) is not intended to be limited to the reference from either the top or bottom unless the context demands it.

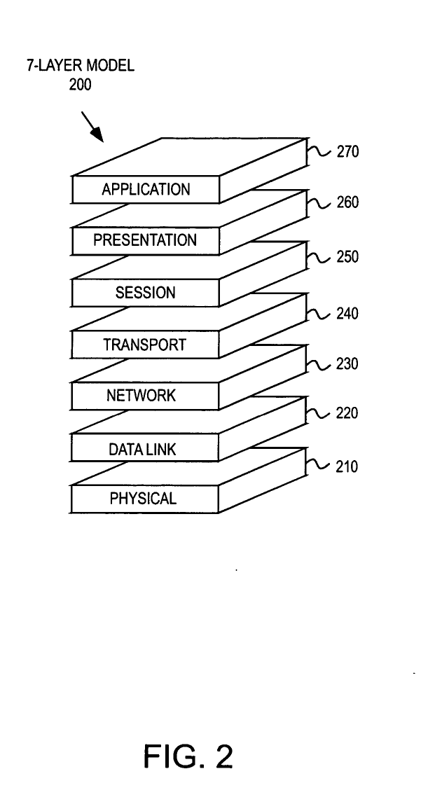

FIG. 2 illustrates an abstract networking model promulgated by the International Standard Organization. This model is also referred to as the basic reference model or the 7-layer model 200 of the Open Systems Interconnection network. Layers 210-230 are referred to as the “lower layers”. Layers 240-270 are referred to as the “upper layers”. The lower layers are concerned with moving packets of data from a source to a destination. The upper layers

The physical layer 210 describes the physical properties of the communications media, as well as how the communicated signals should be interpreted. The data link layer 220 describes the logical organization (e.g., framing, addressing, etc.) of data transmitted on the media. The data link layer for example, handles frame synchronization

The network layer 230 defines the addressing and routing structure of the network. More generally, the network layer defines how data can be delivered between any two nodes in the network. Routing, forwarding, addressing, error handling, and packet sequencing are handled at this layer. This layer is responsible for establishing the virtual circuits when communicating between nodes of the network.

The transport layer 240 is responsible for end-to-end communication of the data between hosts or nodes. The transport layer, for example, performs a sequence check to ensure that all the packets associated with a file have been received. The session layer 250 establishes, manages, and terminates connections between applications. The session layer functions are often incorporated into another layer for implementation.

The presentation layer 260 describes the syntax of data being communicated. The presentation layer aids in the exchange of data between the application and the network. Where necessary, the data is translated to the syntax needed by the destination. Conversions between different floating point formats as well as encryption and decryption are handled by the presentation layer.

The application layer 270 identifies the hosts to be communicated with, user authentication, data syntax, quality of service, users, etc. The types of operations handled by the application layer include execution of remote jobs and opening, writing, reading, and closing files.

Different networks may define the protocol layers in other ways. Moreover, the protocol layers do not need to correspond to distinct layers in the hardware hierarchy. Implementation of a layer may be distributed across multiple levels in a hardware hierarchy. Alternatively, a single hardware element might handle more than one layer of the stack.

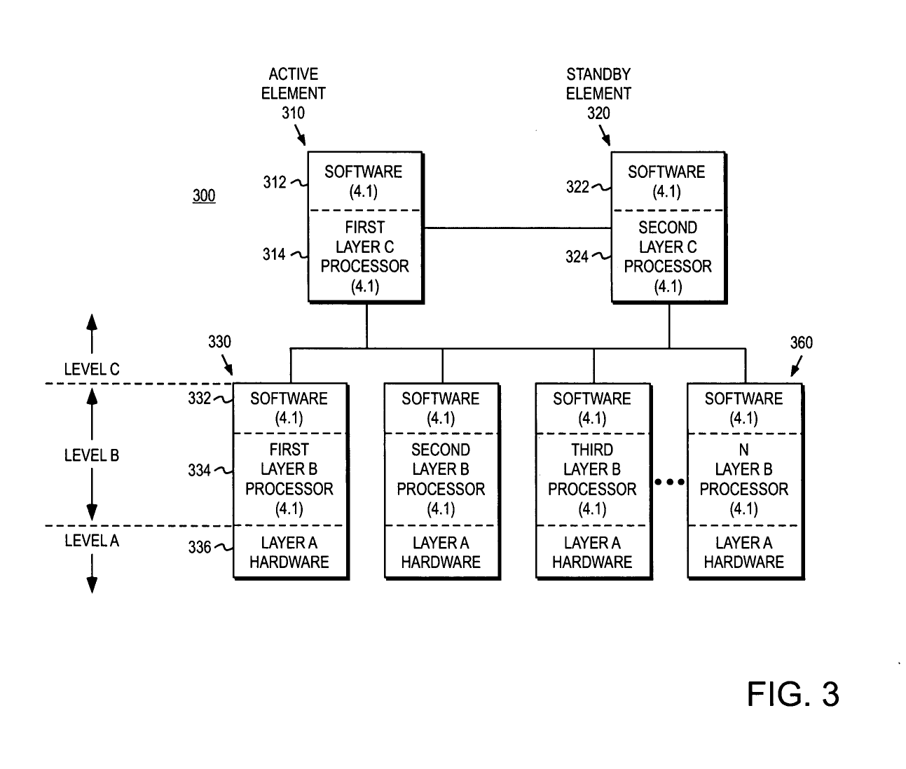

FIG. 3 illustrates one embodiment of an apparatus for implementing a layered protocol for a communications network. The apparatus may be one node 300 of a larger communications network. In one embodiment, for example, node 300 is a router. Node 300 includes a hierarchy of elements for implementing the various protocol layers. There is not necessarily a one-to-one correspondence between layers and elements handling those layers. Thus for example, element 330 handles Layers A and, B, while element 310 handles Layer C and provides the interface to the physical media which connects apparatus 300 with other network nodes. The letter “A” indicates the lowest level in the layered protocol.

The apparatus of FIG. 3 includes redundant elements as well as non-redundant elements. Active elements 310, 320 represent redundant elements. One of the elements is in a standby mode while the other is active. The apparatus provides fail-over capabilities so that the standby processor can assume active status and responsibility for the services provided by the former active processor. In such a case, the formerly active processor is placed into a standby mode or a disabled mode until the event that caused the fail-over is resolved.

Elements 330-360 provide the interface to the physical media carrying the communications. In one embodiment, elements 330-360 are referred to as line cards. Although multiple (n) line cards 330-360 are illustrated, the line cards are not provided with redundancies in this embodiment.

For router nodes, elements 330-360 might be referred to as “data plane” elements while elements 310 and 320 are referred to as “control plane” elements. The data plane examines the destination address or label and sends the packet in the direction and manner specified by a routing table. The control plane describes the entities and processes that update the routing tables. In practice, elements 310 and 320 may include some data plane functions or associated hardware such as a switch matrix. Similarly, elements 330-360 may include some aspects of a control plane.

Processors 314 or 324 may be responsible, for example, for modifying or updating routing tables utilized by the processors of elements 330-360. Lower level processors such as processor 334 are responsible for configuring even lower-level hardware such as hardware 336. Hardware 336 might be a field programmable gate array (FPGA) or an application-specific integrated circuit (ASIC), for example.

Each processor throughout the hierarchy requires a set of processor-executable instructions that determine the implementation of a particular protocol layer by that processor. The processor-executable instructions may be embodied as “software” or “firmware” depending upon the storage medium or the method used to access these instructions. Generally the term software will refer to “processor executable instructions” regardless of the storage medium or the method of access, unless indicated otherwise.

Occasionally the network component must be upgraded to handle new protocols, expansions to existing protocols, or new or changed features. Although hardware upgrades (i.e., replacement of processors) might be required, typically the component can be upgraded through software upgrades. Although different versions of software 312, 322, 332 may reside with the storage medium associated with a particular processor 314, 324, and 334, respectively, an upgrade or change is not effective until the processor has loaded and is executing the desired version. Thus mere storage of a particular version is not sufficient to effect an upgrade or modification. Typically the processors must be reset or re-booted to load a different version of the software.

Software upgrades necessarily disrupt the functioning of the associated processor. Upgrading or modifying the software associated with a processor renders the processor unavailable and effectively nonfunctional throughout the upgrade. Accordingly, the processor cannot perform its intended functions during the upgrade. The apparatus as a whole cannot fully implement the layered protocol as long as any hierarchy is nonfunctional due to the upgrading of its processor. Outages or loss of service of the apparatus as a whole for even a few minutes may be extremely costly thus the amount of time that the apparatus is nonfunctional should be minimized.

One approach is to upgrade the software of all the processors at the same time. Although this can minimize the total amount of time required for the upgrade, this approach is also likely to render the entire apparatus effectively nonfunctional throughout the entire upgrade process thus incurring a large penalty as a result of unavailability.

An alternative staggered upgrade approach staggers the upgrades across the hierarchical levels. This approach requires more time to perform the upgrade of all the software, however, much of the functionality of the apparatus is preserved throughout the upgrade process. In particular, the functioning of an individual layer is substantially preserved while upgrading the software associated with higher protocol layers. When necessary, a layer is transferred from the processor normally handling that layer to a processor at a different hierarchical level in order to preserve some, if not all, of the functionality of the transferred layer during the upgrade of the software associated with the normal processor. Preferably, the data traffic “status quo” should be preserved while upgrading the software.

Prior to execution of the upgrade, the appropriate version of target software is downloaded for each processor. The software may be stored in nonvolatile memory or a non-volatile memory. In one embodiment, the target version software is downloaded to a random access memory local to the associated processor. Typically, the software required for processors at the same hierarchy level will be the same. The software required for a processor at one level is not, however, typically the same as the software required for a processor at a different level because of the different functions performed at the different levels. The downloading process does not impact data traffic.

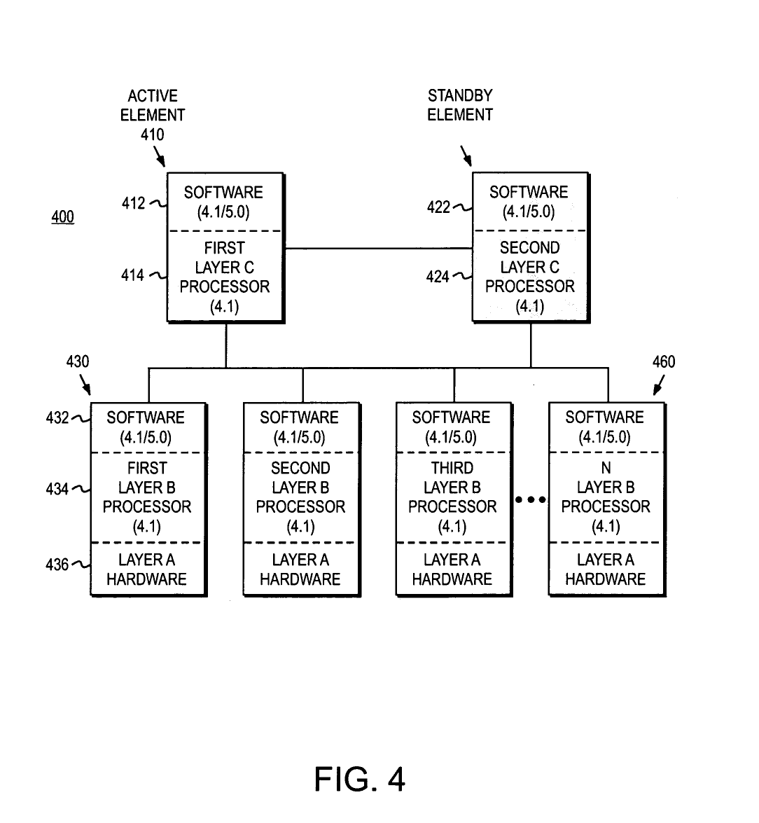

FIGS. 4-11 illustrate this upgrade process graphically for upgrading a node 400 from a starting version (4.1) to a target version (5.0) of software.

FIG. 4 illustrates the version status of software stored and used by the elements after first downloading the target version. After the download, both the starting version and the target version of software are present for each element. Thus software 412, 422 includes version 4.1 and 5.0 appropriate for processors 414 and 424. Similarly, elements 430-460 have versions 4.1 and 5.0 of the software 432 appropriate for the respective processor 434. The hardware associated with some layers such as the Layer A hardware 436 may only require the re-programming of registers with new values to implement the desired changes for that layer. The active element 410 controls the upgrade process until the point at which element 410 must be upgraded.

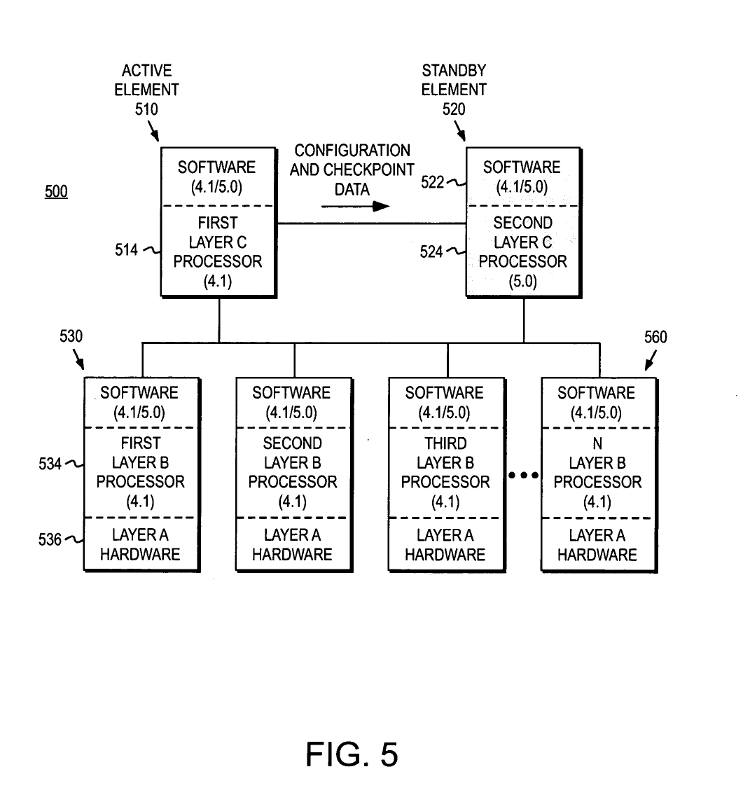

Referring to FIG. 5, the software 522 associated with the standby element 520 is updated first. This is accomplished by performing a reset of processor 524 with the boot vector directed to the target version of the software. After the reset, standby element 520 is executing the target version of the software. The standby element attempts to synchronize with the active element. The standby element retrieves configuration information and checkpoint data from the active element for synchronization. The standby element stores information using the updated version of any database as dictated by the target version of the software. This update has no impact on lower level layers handling data traffic such as the Layer A hardware 536 for elements 530-536.

If an update of the redundant elements is the only update required, then fail-over mechanisms can be used to update the active elements. Using existing fail-over protocols, the active/standby status of the two elements 510, 520 can be swapped and a reset can be performed on processor 514 similar to that previously performed on processor 524. In one embodiment, when more than one level must be updated, however, the upgrade process proceeds to update lower levels before completely updating the current level. In the event of a failure during the upgrade process, the apparatus 500 may return to either the starting version or the target version of the software depending upon when the failure occurred.

Although the next lower level of the hardware hierarchy includes several processors 534, these processors are not configured to provide redundancy. Thus performing a reset on these processors may terminate connections or sessions requiring Layer B functionality. Layer B might provide, for example, “keep alive”, “hello” or other connection maintenance functionality such as that found in layer 3 of the OSI model. Such connection maintenance functionality may be required to support various protocols and connections including the Intermediate System-to-Intermediate System (IS-IS) and Open Shortest Path First routing protocols, label switch paths (LSP), etc. If this functionality is absent, one or more connections or sessions will be terminated despite the ability of lower level layers to otherwise continue to forward packets. Failure to provide this functionality will result in the loss of various connections and sessions.

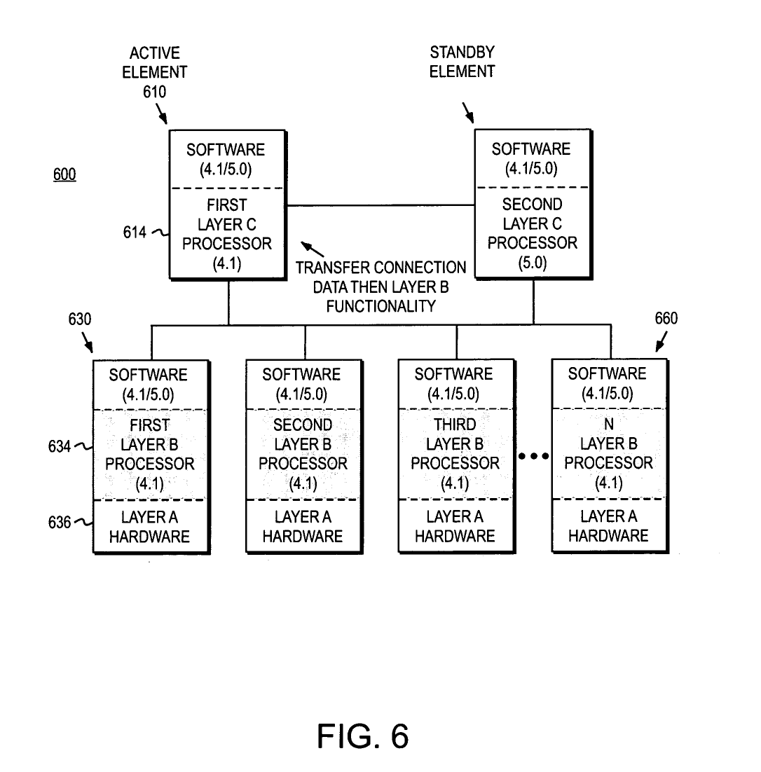

Referring to FIG. 6, Layer B is moved from the processor 634 at one hierarchical level to a processor 614 at a higher hierarchical level. The layer is thus moved to another processor for handling. Processor 614 reads the connection data from elements 630-660 prior to the transfer. Connection data includes both the static configuration information such as the types of interfaces as well as the dynamic state information regarding the protocols executing on those interfaces.

Layer B is then transferred from the processors 634 of elements 630-660 to processor 614. Processor 614 of active element 610 executes program code supporting Layer B functionality with the initial conditions established by the connection and configuration information read from elements 630-660. This is equivalent to moving the control plane from one processor to another processor at a different location in the processor hierarchy.

After Layer B functionality is transferred, a reset is performed on the processors 634 normally associated with Layer B processing. The boot vector is directed to the target version of the software. This activity does not disrupt the data traffic handled by the Layer A hardware of elements 630-660.

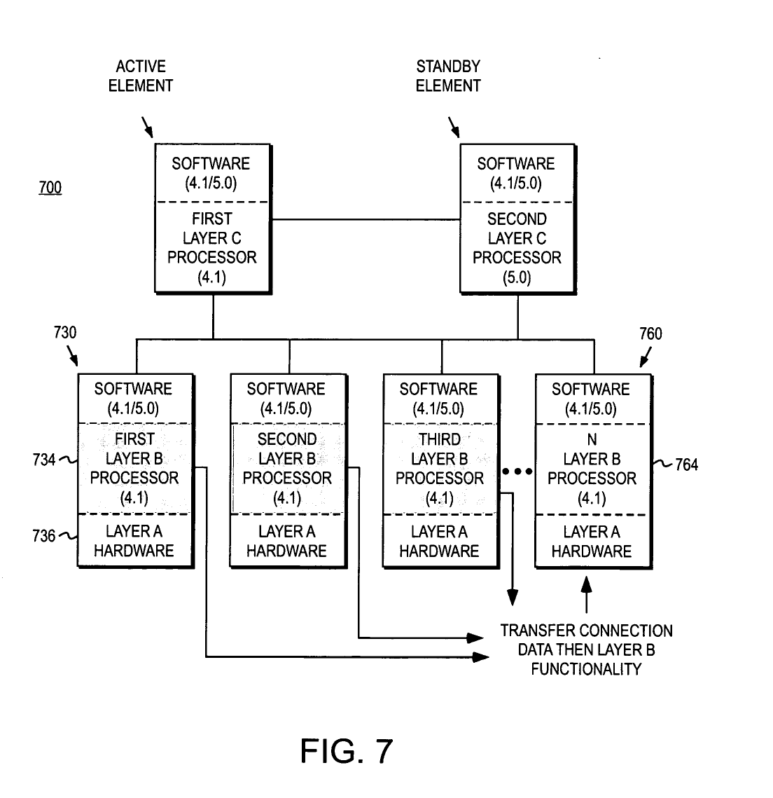

FIG. 7 illustrates an alternative embodiment in which the Layer B functionality for node 700 is transferred from one processor 734 to another processor 764 at the same location in the processor hierarchy. Processor 764 is not a dedicated redundant resource nor is element 760 redundant to 730. The Layer A hardware 736 of element 730, for example continues to function while relying on a different processor 764 for its Layer B functionality. Clearly not all of the processors 734 can be upgraded at the same time. In one embodiment, the software for all but one of the processors is upgraded at the same time. In an alternative embodiment, only the software associated with a single processor is upgraded at one time.

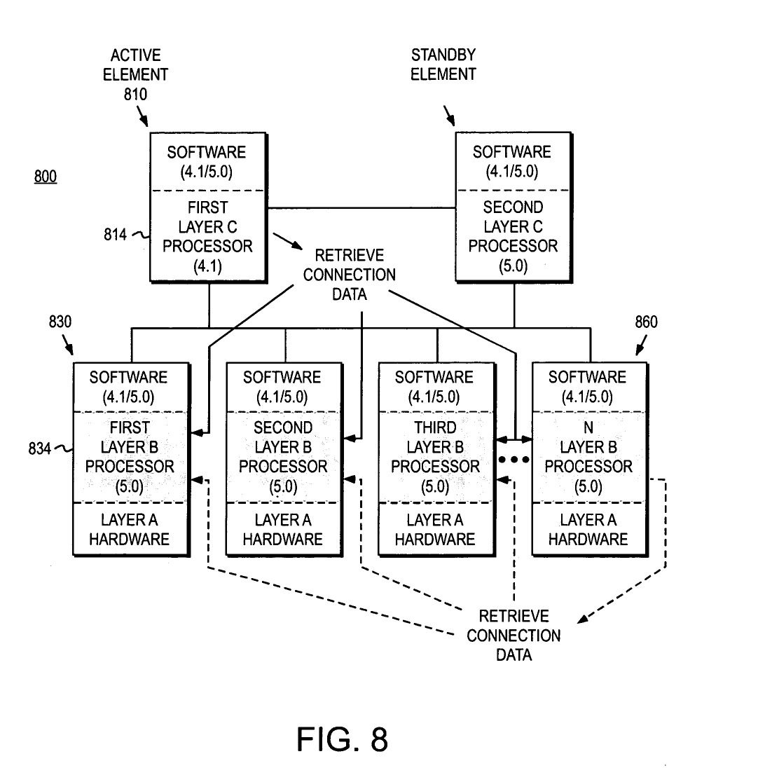

FIG. 8 illustrates the node 800 after the reset. Processors 834 of elements 830-860 are executing the target version (5.0) of the software. Processors 834 of elements 830-860 then retrieve the connection data associated with Layer B from either the hierarchically higher processor 814 of active element 810 or the processor 864 residing at the same location in the processor hierarchy depending upon where the Layer B functionality was previously transferred.

The Layer A hardware must be updated to support the various protocol changes resulting from the software update. Reconfiguration of the Layer A hardware necessarily disrupts the traffic handled by the Layer A hardware, however, the reconfiguration primarily entails writing values to registers of low level hardware such as ASICs. Instead of disrupting Layer A functionality throughout the upgrade of the node, Layer A functionality is disrupted only for the relatively short period of time required to reconfigure the low-level hardware. In contrast to the update procedure for the higher level processors, reconfiguration of low level hardware such as ASICs is on the order of fractional seconds to seconds.

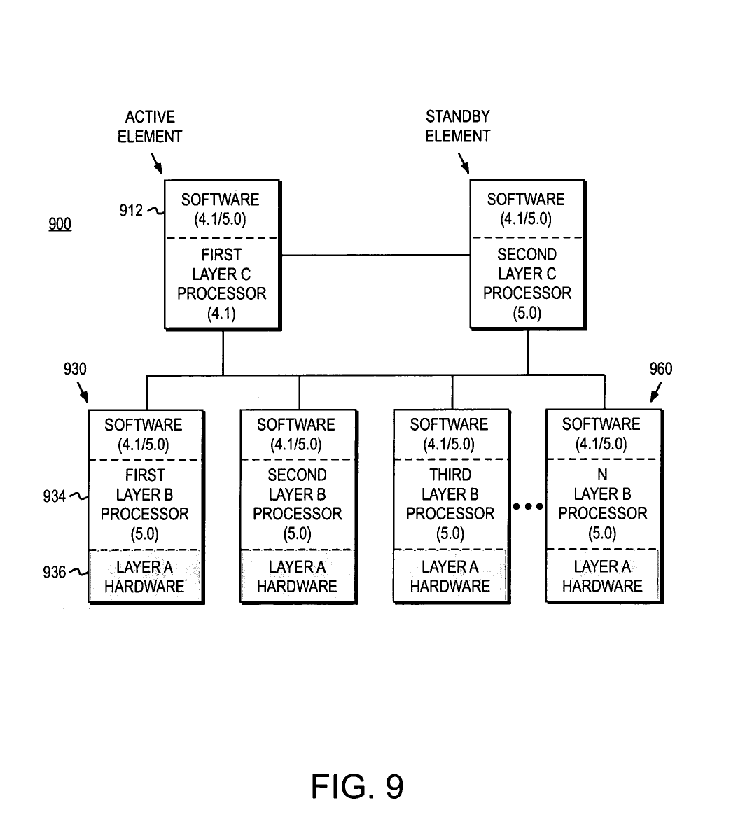

FIG. 9 illustrates reconfiguring the Layer A hardware 936 of elements 930-960 for node 900. Processors 934 configure their respective Layer A hardware 936 to support the functionality determined by the software upgrade. Following the re-configuration of the Layer A hardware, the transfer of Layer B functionality back to the processors of elements 930-960 is completed. The processors 934 of elements 930-960 begin executing Layer B program code using the retrieved connection data. Processor 934 of elements 930-960 handle the control plane for the Layer A hardware 936. Thus the control plane is restored to the elements normally associated with Layer B functionality.

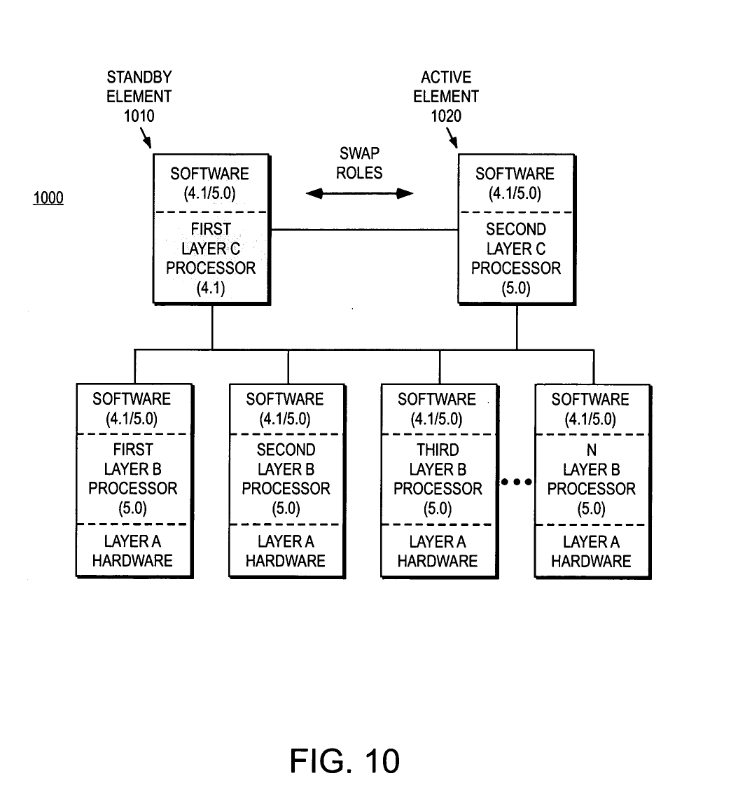

In order to finish the upgrade process, software 912 can be updated using typical fail-over mechanisms to avoid disruption. Referring to node 1000 of FIG. 10, the active and standby status of elements 1010, 1020 is swapped such that element 1010 is now in standby mode and element 1020 is the active element. Active element 1020 assumes control for the remainder of the upgrade process.

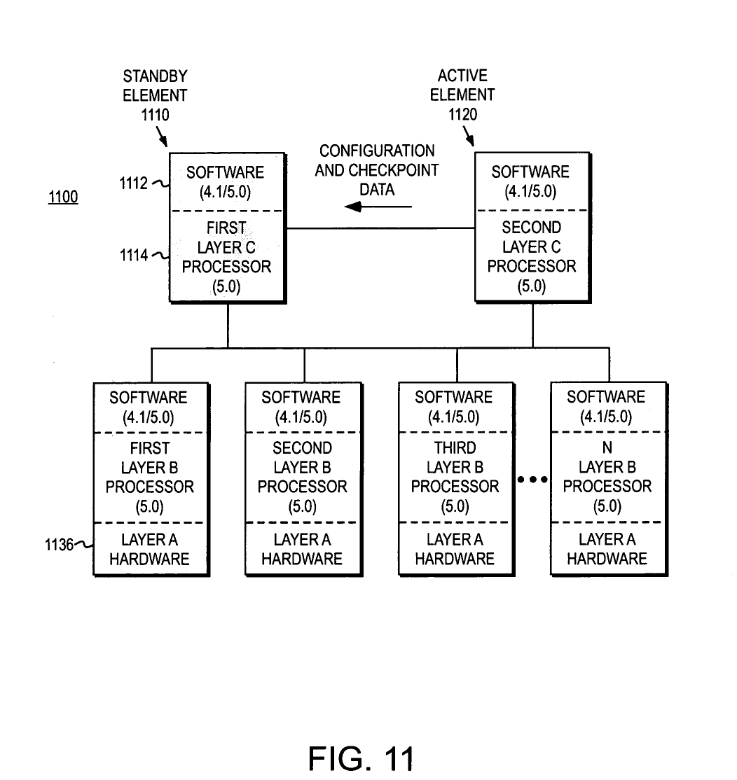

FIG. 11 illustrates the result of a reset of processor 1114 using a boot vector pointing to the target version of the software 1112. After the reset, processor 1114 is executing the target version of the software. Standby element 1110 then retrieves configuration and checkpoint information from active element 1120 in order to synchronize with active element 1120. The upgrade of the software at this level of the hierarchy does not disrupt the data traffic handled by the Layer A hardware 1136.

Booting any of the processors using the target version of the software might take considerable time, however, the functionality of the processors has been “covered” either through redundancy or by moving layer support to a processor at either the same or a different level in the hierarchy. The time required to transfer a control plane back and forth is very short compared to the time required to complete the upgrade and bring the processors online with the target version of software. Such transfer does not disrupt the data traffic handled by the Layer A hardware 1136.

The static component of the Layer B connection data (i.e., the configuration data) is not permitted to change throughout the upgrade of the software associated with Layer B. For a router, this could imply that alarms, requests to establish/terminate connections, and routing table updates/modifications are ignored. Network components external to node 1100 may terminate connections, for example, but the termination will not be recognized by node 1100 until the upgrade has completed and the termination has been subsequently detected by node 1100.

Thus some functionality is lost during the upgrade process, however, the traffic moving capabilities having the greatest impact on availability are maintained throughout the upgrade process. The layered protocols are typically robust and they permit node 1100 to re-detect conditions that were ignored during the upgrade process in the event that such conditions were not resolved prior to the completion of the software upgrade.

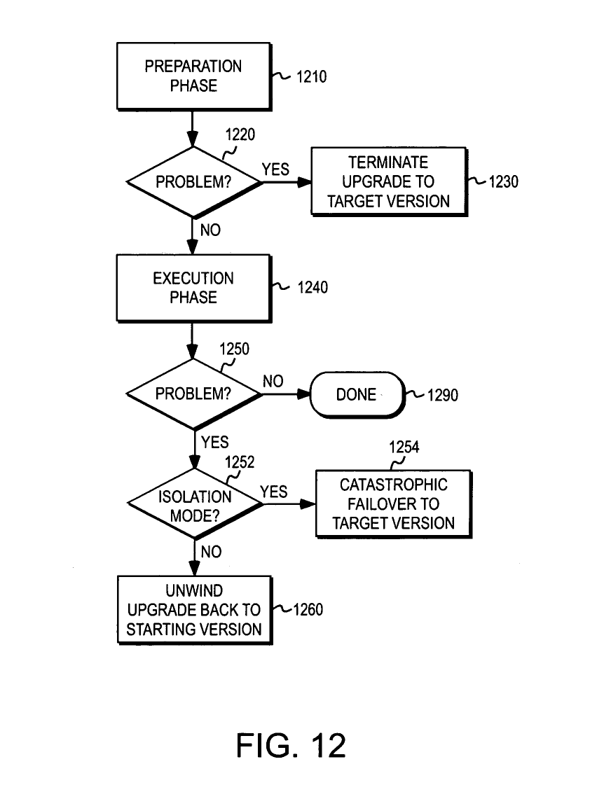

To reduce the risk of failure in the upgrade process, the upgrade process is performed in two phases: a preparation phase and an execution phase as indicated in FIG. 12. The preparation phase is performed in step 1210. If problems are discovered in the preparation phase as determined by step 1220, the upgrade to the target version is terminated in step 1230. Otherwise, the upgrade process continues with the execution phase in step 1240. If no problems occur during the execution phase, the process is completed with step 1290.

If problems are encountered during the execution phase as determined by step 1250, the upgrade process may either be “unwound” to the starting version of the software or alternately catastrophic failure mechanisms may be used to complete the upgrade to the target version of the software. In one embodiment, if a problem occurs after entering an isolation mode as determined by step 1252, then the upgrade process is terminated and catastrophic failover mechanisms are used to upgrade the software to the target version in step 1254. If the problem occurs prior to entering the isolation mode, then the upgrade process is “unwound” to the starting version of the software in step 1260. The isolation mode is a mode that prevents the node from accommodating externally requested configuration changes.

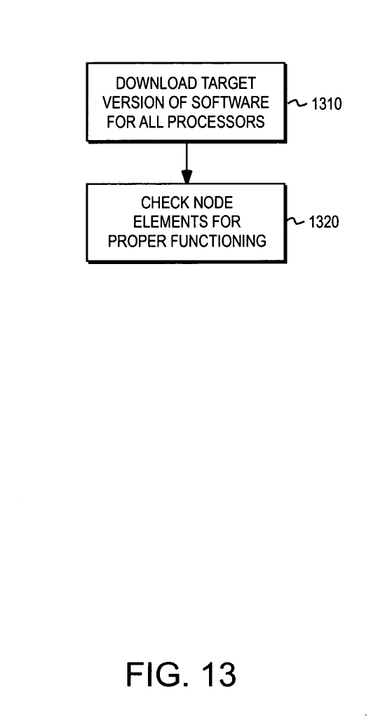

FIG. 13 illustrates one embodiment of the preparation phase. In step 1310, the target version of the software is downloaded to memory for each processor in the element hierarchy that needs to have its associated software upgraded. The starting version may be preserved to enable restoration to the starting version of the software in the event of a failure in the upgrade process.

In step 1320, the node is checked to ensure that all elements are functioning properly. The preparation phase cannot complete successfully unless all elements have full operational functionality. The determination of operational functionality might include checking whether the node has operational redundancy, whether all elements are working, and whether any element is in a transitional state (e.g., being reset, updated, etc.).

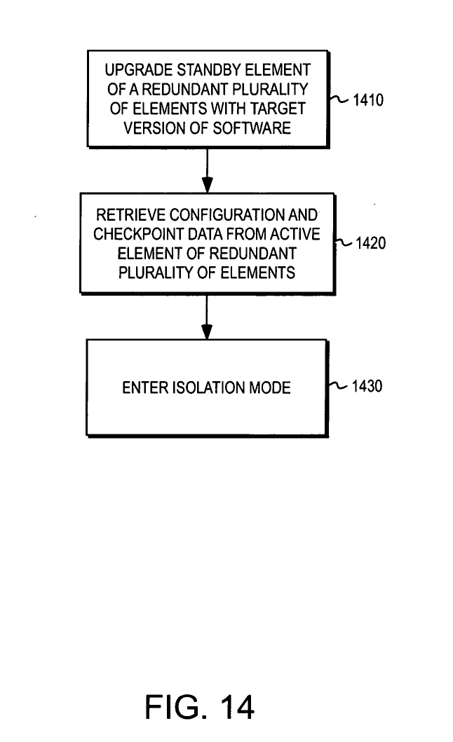

FIG. 14 illustrates one embodiment of the beginning of the execution phase. In step 1410, a standby element of a redundant plurality of elements is upgraded to a target version of software. In one embodiment, this is accomplished by performing the reset previously described. In step 1420, the standby element retrieves configuration and checkpoint data from an active element of the redundant plurality of elements. The standby element performs any necessary data conversions required to bring the retrieved data into conformance with the formats dictated by the target version of the software. At this point, the node no longer has redundancy protection.

The node is placed into isolation mode in step 1430 to prevent configuration changes. In the case of a router, for example, alarms, requests to establish/terminate connections, and routing table modifications are ignored.

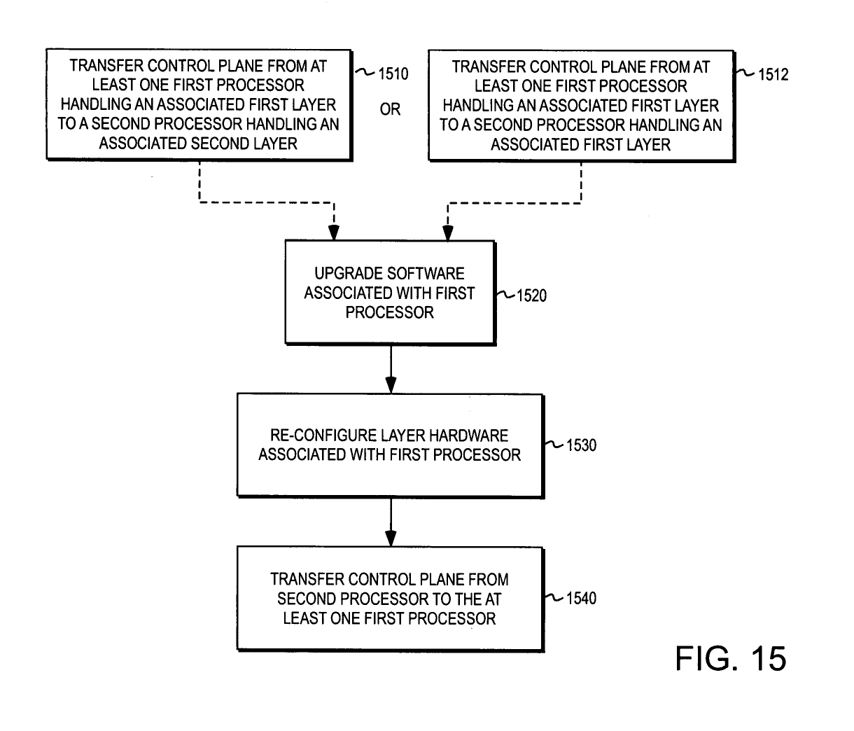

The software for lower level processors may also be upgraded. As previously indicated, however, layer functionality must be preserved throughout the upgrade. In order to preserve layer functionality, the associated control plane is transferred from a processor at one level of the element hierarchy to a processor at the same level or another level of the element hierarchy as indicated in FIG. 15.

In one embodiment, a control plane is transferred from at least one first processor handling a first layer to a second processor handling a second layer in step 1510. This is equivalent to transferring the layer or layer portion handled by the first processor to the second processor handling another layer or layer portion. The node may have a single first processor or n first processors such as the processors 434 associated with each of elements 430-460.

The first and second processors are located at different levels of the element hierarchy. Effectively the layer or portion of a layer handled by a first processor is transferred to a second processor at another level of the hierarchy. In contrast to the redundancy approach, all the processors (e.g. 434) handling the first layer or first layer portion prior to the transfer can have a software upgrade at substantially the same time. The redundancy approach requires swapping the roles of active and standby components such that upgrades for all elements at the same level cannot occur substantially simultaneously.

In an alternative embodiment, a control plane is transferred from at least one first processor handling an associated first layer to a second processor handling an associated first layer in step 1512. This is equivalent to transferring the layer or layer portion handled by the first processor to a second processor handling another instance of the same layer or layer portion. The node may have a single first processor or n first processors such as the processors 434 associated with each of elements 430-460.

The first and second processors are located at the same level of the element hierarchy. Effectively the layer or portion of a layer handled by a first processor is transferred to a second processor at the same level of the hierarchy. In contrast to the redundancy approach, the second processor is not duplicative or redundant. Prior to transfer of the control plane, the second processor is handling its own instance of the same layer or layer portion.

Regardless of whether the control plane is transferred to a processor at the same or a different level of the element hierarchy, after the transfer the software associated with the at least one first processor is upgraded in step 1520. This may be accomplished by using a soft reset to force the first processor(s) to load the target version of the software as previously described. This upgrade does not impact data traffic handled by lower level layers. In step 1530, the lower level layer hardware associated with the first processor is re-configured. This re-configuration disrupts the data traffic handled by the lower level layer hardware. In step 1540, the control plane is transferred back to the at least one first processor.

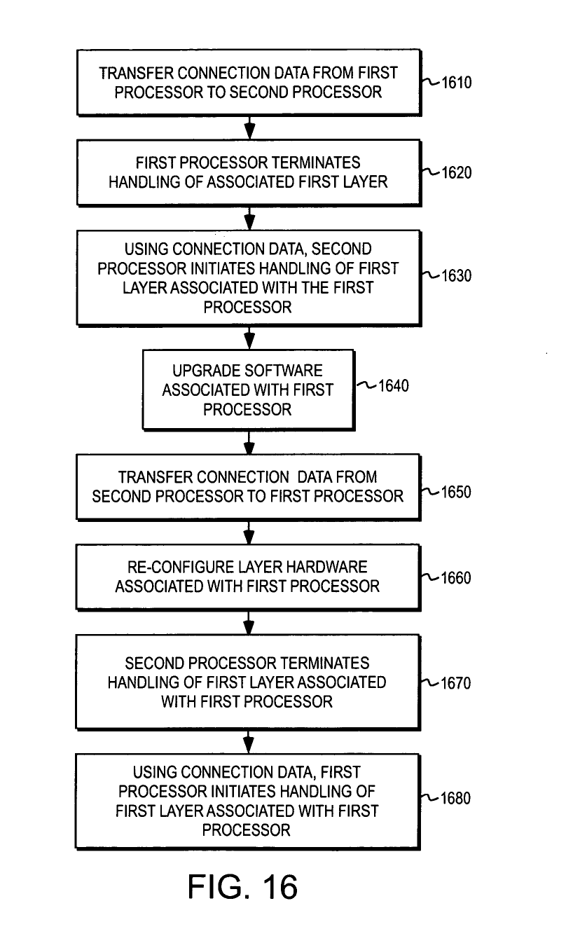

FIG. 16 illustrates the transfer of the control plane or layer functionality in greater detail. In step 1610, a first processor handling a first layer provides connection data (i.e., the static configuration and dynamic state) to a second processor. Depending upon the location of the second processor in the element hierarchy, the second processor is either handling a second layer or another instance of the first layer. In step 1620, the first processor terminates handling first layer functions. Using the connection data, the second processor initiates handling of the first layer functions previously associated with the first processor in step 1630. Thus a first layer being handled by the first processor is transferred to a second processor.

The software upgrade for the first processor is performed in step 1640. During the upgrade, the second processor is handling first layer functionality. This might include, for example “hello”, “keep alive”, or other functionality required to preserve the status quo with respect to other nodes in the communications network.

After the upgrade, the first processor retrieves the connection data from the second processor in step 1650. The lower level hardware associated with the first processor is re-configured in step 1660. The second processor terminates handling first layer functions in step 1670. The first processor initiates handling first layer functions in step 1680 using the connection data. This is equivalent to transferring the first layer being handled by the second processor back to the first processor for handling.

The re-configuration of the low level hardware is typically required in order to support the protocol modifications at the data traffic layer. The connection data preserved throughout the upgrade of the control plane for the low level hardware must be re-mapped or otherwise modified to ensure compatibility with the upgraded versions of the protocols instituted by the software upgrade.

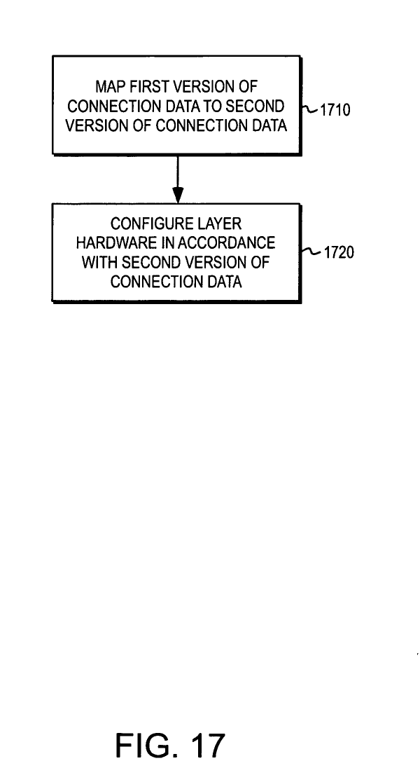

FIG. 17 illustrates one embodiment of re-configuring the low-level hardware. In step 1710, a first version of connection data compatible with a first version of a layer is mapped to a second version of connection data compatible with a second version of a layer. The connection data includes static configuration data as well as dynamic state data. In step 1720, the low-level layer hardware is re-configured in accordance with the second version of connection data. This might entail, for example, writing values to a number of registers. This re-configuration disrupts the data traffic handled by the low-level hardware, but the amount of time required to write values to the registers is on the order of fractions of a second to seconds and thus of sufficiently short period of time to avoid causing other nodes in the communications network from taking corrective action such as re-routing communications around the node being updated.

An alternative approach to re-configuring the low-level hardware can potentially decrease the amount of time needed for re-configuration by reducing the number of write operations required. The aforementioned re-mapping operation does not necessarily result in a change in value for every register of the low-level layer hardware. The number of write operations might be significantly reduced if values are written only to the registers that have changed values.

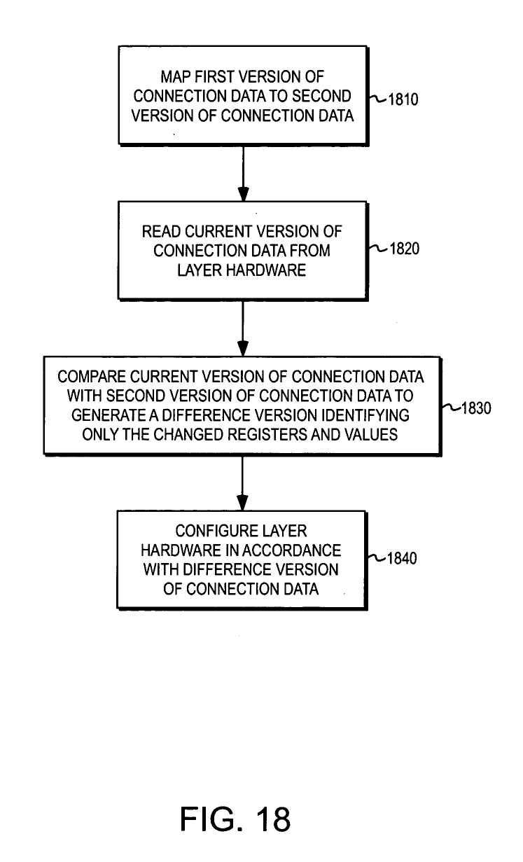

FIG. 18 illustrates one embodiment of the alternative approach to re-configuring the low-level hardware. In step 1810, a first version of connection data compatible with a first version of a layer is mapped to a second version of connection data compatible with a second version of the layer. The first and second versions of the layer refer to the pre- and post-upgrade versions of the layer.

A read operation is performed to retrieve the current version of the connection data from the low-level layer hardware in step 1820. The current connection data is compared to the second version of the connection data to identify a difference (DIFF) version of the connection data in step 1830. The DIFF version identifies only the registers that have changes in value and what those values should be. The DIFF version thus identifies only the locations that actually require a change. The low-level hardware is then re-configured in accordance with the difference version of the connection data in step 1840. The difference version can potentially decrease the amount of time that the data traffic is disrupted by eliminating the time spent writing to registers that do not require changes.

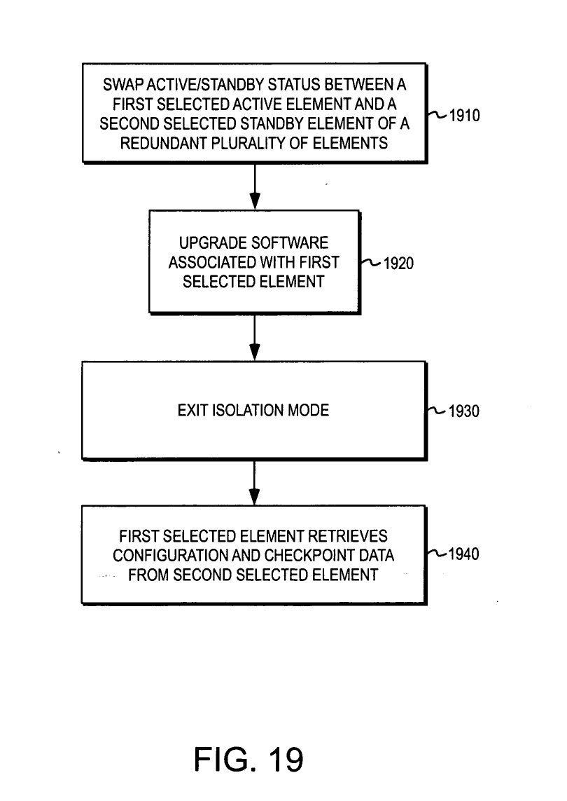

The remaining elements of the redundant plurality of elements may now be upgraded as indicated in FIG. 19. Until this point the upgrade process has been controlled by the active element of the redundant plurality of elements. A first selected active element swaps active/standby status with a second selected standby element in step 1910. The first selected element is now a standby element and the second selected element is now the active element. The second selected element is now responsible for controlling the remainder of the upgrade process.

The first selected element is upgraded to a target version of the software in step 1920. This may be accomplished, for example, by performing a reset of the processor with a boot vector directed to the target version of the software. In one embodiment, the node exits the isolation mode in step 1930 to enable configuration changes. In step 1940, the first selected element retrieves configuration and checkpoint data from the second selected element. At this point the redundant plurality of elements are synchronized and capable of providing redundancy protection. In an alternative embodiment, step 1940 is performed prior to step 1930 to ensure redundancy before exiting the isolation mode.

Methods and apparatus for modifying a layered protocol communications apparatus have been described. For example, software is updated for different layers without disrupting lower layer data traffic. In particular functionality is preserved for a layer either by providing a redundant element to handle the layer or by transferring the layer to an element at the same or a different hierarchical level of the layered protocol hierarchy.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method of modifying a layered protocol communication apparatus, comprising:
a)transferring a control plane from a first processor handling a first layer to a second processor handling a second layer of a layered protocol.

2. The method of claim 1 wherein the transfer of the control plane from the first processor to the second processor does not interrupt data traffic handled by any layers lower than the first layer.

3. The method of claim 1 wherein step a) further comprises:
i) providing connection data from the first processor to the second processor;
ii) halting the first processor's handling of the first layer; and
iii) initiating handling of the first layer by the second processor using the connection data.

4. The method of claim 1 further comprising:
b) modifying software associated with the first processor.

5. The method of claim 4 wherein step b) comprises performing a soft reset of the first processor with a boot vector directed to a target version of the software.

6. The method of claim 4 further comprising:
c)transferring the control plane from the second processor to the first processor.

7. The method of claim 6 wherein the transfer of the control plane from the second processor to the first processor does not interrupt data traffic handled by any layers lower than the first layer.

8. The method of claim 6 wherein step c) further comprises:
i) providing connection data from the second processor to the first processor;
ii) halting the second processor's handling of the first layer; and
iii) initiating handling of the first layer by the first processor using the connection data.

9. The method of claim 6 further comprising:
d) mapping a first version of the connection data to a second version of the connection data; and
e) configuring a lower layer hardware in accordance with the second version of the connection data, wherein the lower layer is lower than the first layer.

10. The method of claim 6 further comprising:
d) mapping a first version of the connection data to a second version of the connection data;
e) reading a current version of the connection data;
f) comparing the second version and the current version of the connection data to generate a difference version identifying only the changed registers and values; and
g) configuring a lower layer hardware in accordance with the difference version of the connection data, wherein the lower layer is lower than the first layer.

11. A method of modifying a layered protocol communication apparatus, comprising:
a) transferring a first layer handled by a first processor to a second processor handling a second layer of a layered protocol.

12. The method of claim 11 wherein the transfer of the first layer from the first processor to the second processor does not interrupt data traffic handled by any layers lower than the first layer.

13. The method of claim 11 wherein step a) further comprises:
i) providing connection data from the first processor to the second processor;
ii) halting the first processor's handling of the first layer; and
iii) initiating handling of the first layer by the second processor using the connection data.

14. The method of claim 11 further comprising:
b) modifying software associated with the first processor.

15. The method of claim 14 wherein step b) comprises performing a soft reset of the first processor with a boot vector directed to a target version of the software.

16. The method of claim 14 further comprising:
c)transferring the first layer from the second processor to the first processor for handling.

17. The method of claim 16 wherein the transfer of the first layer from the second processor to the first processor does not interrupt data traffic handled by any layers lower than the first layer.

18. The method of claim 16 wherein step c) further comprises:
i) providing connection data from the second processor to the first processor;
ii) halting the second processor's handling of the first layer; and
iii) initiating handling of the first layer by the first processor using the connection data.

19. The method of claim 16 further comprising:
d) mapping a first version of the connection data to a second version of the connection data; and
e) configuring a lower layer hardware in accordance with the second version of the connection data, wherein the lower layer is lower than the first layer.

20. The method of claim 16 further comprising:
d) mapping a first version of the connection data to a second version of the connection data;
e) reading a current version of the connection data;
f) comparing the second version and the current version of the connection data to generate a difference version identifying only the changed registers and values; and
g) configuring a lower layer hardware in accordance with the difference version of the connection data, wherein the lower layer is lower than the first layer.

21. A communication apparatus comprising:
a hierarchy of processors including a first processor associated with a first layer and a second processor associated with a second layer of a layered protocol, wherein a control plane associated with the first processor is transferred to the second processor prior to modifying a software associated with the first processor.

22. The apparatus of claim 21 wherein the apparatus is at least one of a network router and a network switch.

23. The apparatus of claim 21 wherein the first processor provides the second processor with connection data describing a data plane to facilitate the transfer of the control plane.

24. The apparatus of claim 21 wherein the control plane is transferred back to the first processor after the software modification.

25. The apparatus of claim 21 wherein the first processor performs a soft reset with a boot vector pointing to a target version of the software for modifying of the software
